(19) United States
(12) Patent Application Publication
(10) Pub. No.: US 2022/0366340 A1
(43) Pub. Date: Nov. 17, 2022

(54) SMART ROLLOUT RECOMMENDATION SYSTEM

(71) Applicant: Microsoft Technology Licensing, LLC, Redmond, MA (US)

(72) Inventors: Tianyi CHEN, Sammamish, WA (US); Jesus BARRERA RAMOS, Snohomish, WA (US); Dhirendra BHUPATI, Sammamish, WA (US); Muskan KUKREJA, Redmond, WA (US)

(21) Appl. No.: 17/319,704

(22) Filed: May 13, 2021

(51) Int. Cl. G06Q 10/06; G06Q 30/02; G06F 8/65

(52) U.S. Cl. CPC G06Q 10/06375; G06Q 10/06395; G06Q 30/0202; G06F 8/65; G06F 21/57

(57) ABSTRACT

A smart rollout recommendation system uses a modernization score that indicates a likelihood of accepting a change in an existing product to identify at least one tenant of a plurality of tenants eligible to receive the change and the timing of the rollout. The modernization score is generated using a set of attributes extracted from tenant profiles and a machine learning model.

### BACKGROUND

Software as a service (“SaaS”) is a method for delivering software applications over the Internet on demand and typically on a subscription basis. With SaaS, cloud providers host and manage the software application and underlying infrastructure, and handle any maintenance, like software upgrades and security patching. Users connect to the application over the Internet, usually with a web browser on their phone, tablet, or personal computer.

For every SaaS business-to-business (“B2B”) product, new features are rolled out routinely (e.g., monthly, semi-annually, or annually) and new sale packages with different tiers of combined services are marketized and promoted regularly to improve customer experiences and increase SaaS provider revenues. Rollout of new product features or promotion of new service bundles is typically organized and planned in multiple waves for business customers, where SaaS providers first expose to a group of pilot customers for trials and then gradually release to the wider audience. Fast rollout of new product services (including features, sale promotions, etc.) can help SaaS providers receive in-time responses of customer feedback and benefit from faster iterations of improvement in product.

SaaS business customers are typically heterogeneous in complexity, user behaviors, security and compliance requirements, product stability, and novelty needs. Providing customers with the appropriate services becomes extremely critical for software providers like Microsoft, Google and online service providers like Amazon, Netflix to keep customer engaged and retained and reduce churn rate against competitors and alternatives.

### BRIEF SUMMARY

Systems and methods for providing smart rollout recommendations are described. By identifying who and when to roll out new features, it is possible to obtain a more targeted assessment of potential issues with new or updated features and update and deploy software applications more effectively.

A method carried out by rollout services can then include requesting a modernization score for each of a plurality of tenants associated with an existing product, the modernization score indicating a likelihood of accepting a change in the existing product and being computed for each tenant using at least a weighted set of attributes associated with that tenant, the weighted set of attributes corresponding to at least application software usage, security, and user device management; obtaining the modernization score for each of the plurality of tenants indicating the likelihood of accepting the change; identifying at least one tenant of the plurality of tenants eligible to receive the change based on the corresponding modernization score; and providing the change to the at least one tenant of the plurality of tenants eligible to receive the change. The change can be rolled out in waves according to the modernization scores.

The modernization score can be generated by receiving user specific data for a plurality of users associated with an existing product; extracting, from the user specific data, a set of attributes for each user of the plurality of users, the set of attributes corresponding to at least application software usage, security, and user device management; determining, using at least the set of attributes and a machine learning model, a weight for each attribute in the set of attributes; determining a modernization score indicating a likelihood of accepting a change in an existing product for each tenant of the plurality of tenants using the set of attributes corresponding to that tenant and the associated weights; and providing the modernization score indicating the likelihood of accepting of the change in the existing product determined for each user of the plurality of users.

Calibration of the model used for generating the modernization score can include receiving, from a tenant of an existing product, feedback regarding a change in the existing product; receiving a set of attributes associated with the tenant, the set of attributes corresponding to at least application software usage, security, and user device management and being used to compute a modernization score indicating a likelihood of tenants to accept changes in the existing product, wherein each attribute of the set of attributes has a corresponding weight; determining, using the feedback, the set of attributes, and a machine learning model, an importance value for each attribute in the set of attributes; and updating the corresponding weight of each attribute of the set of attributes based on the determined importance value, wherein the updated corresponding weight is used to compute the modernization score.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example operating environment in which various embodiments of the invention may be practiced.

FIG. 2 illustrates an example process flow for providing smart rollout recommendations according to certain embodiments of the invention.

FIG. 3 illustrates an example process flow for determining a modernization score indicating a likelihood of accepting a change in an existing product according to certain embodiments of the invention.

FIG. 4 illustrates an example process flow for providing model calibration in a system for providing smart rollout recommendations according to certain embodiments of the invention.

FIG. 5 illustrates an example smart rollout recommendation system workflow according to an embodiment of the invention.

FIG. 6 illustrates an example smart rollout recommendation system cloud services workflow according to an embodiment of the invention.

FIGS. 7A-7C show pseudocode for operations shown in FIG. 6.

FIG. 8 illustrates an example mapping of modernization score to wave rollout recommendation according to certain embodiments of the invention.

FIG. 9 illustrates an example flowchart diagram to describe an ML-driven calibration model according to an embodiment of the invention.

FIG. 10 illustrates components of an example computing system that may be used in certain embodiments described herein.

### DETAILED DESCRIPTION

Systems and methods for providing smart rollout recommendations are described. By identifying who and when to roll out new features, it is possible to obtain a more targeted assessment of potential issues with new or updated features and update and deploy software applications more effectively.

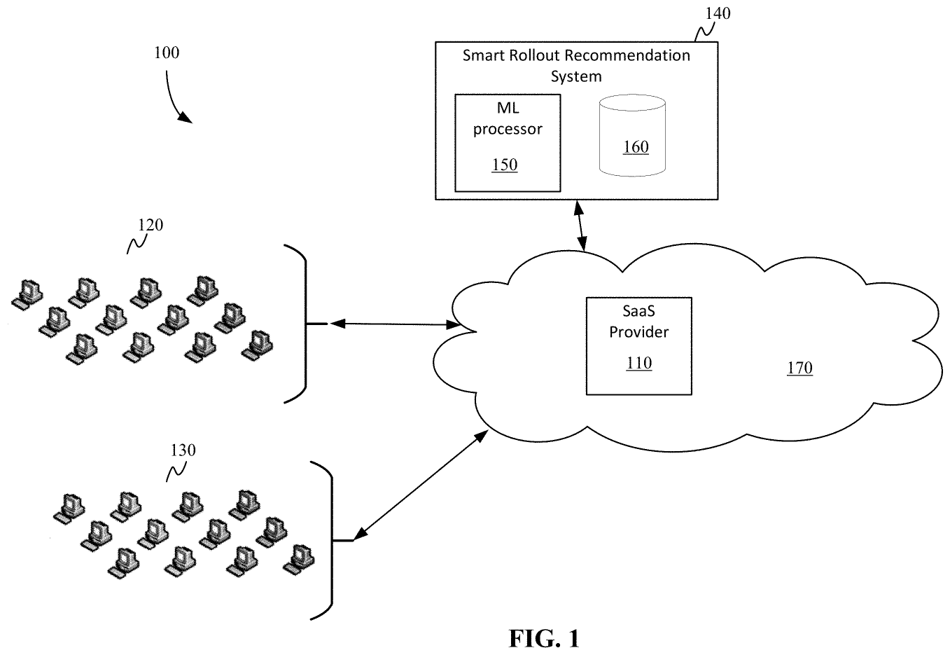

FIG. 1 illustrates an example operating environment in which various embodiments of the invention may be practiced. Referring to FIG. 1, the example operating environment 100 can include a SaaS provider 110 that provides applications and services (e.g., B2B products) for a variety of tenants (e.g., tenant 120 and tenant 130). Each tenant (e.g., tenant 120 and tenant 130) include a plurality of computing devices. In some cases, a tenant may have thousands of computing devices using the applications of the SaaS provider 110. Each computing device may be a specific-purpose device or a general-purpose device that has the ability to run one or more applications. The user computing device may be, but is not limited to, a personal computer, a reader, a mobile device, a personal digital assistant, a wearable computer, a smart phone, a tablet, a laptop computer (notebook or netbook), a gaming device or console, an entertainment device, a hybrid computer, a desktop computer, or a smart television. In some cases, the user computing device may include various IoT devices, such as, but not limited to, a location tracker, access control, and an in-car system.

SaaS provider 110 may have new features and updates to be rolled out routinely (e.g., monthly, semi-annually, or annually) to some or all of the tenants. The are several different methodologies currently used during a new product rollout.

In one example, SaaS providers use a throttling curve to gradually rollout new products, typically starting from less than 1% of the overall business customers, waiting days or weeks for the next wave, and then increase rollout rates little by little to 100%. However, this methodology is conservative and slow, resulting in rollouts that take weeks for new feature rollout and months to years for new product, before reaching 100% of the customers. With the fast growth in software and online services, customers often become frustrated by the slow and unpredictable improvement of our services and opt out for competitors and alternatives.

In another example, SaaS providers randomly select a subset of devices or users within each business customer for early rollouts of new product features. However, the random device selection used in this methodology creates inconsistent product experiences under the same business customer deployment, resulting in user confusion and IT administrator overhead to manage individual devices and escalations. IT administrators also expect to have their override capacities to decide and manage a portion of their devices for experiments and pilot studies according to their customized business needs.

In yet another example, SaaS providers rollout new products and/or features by customer size (e.g., small to large), industry, country, or other category. However, low confidence in rollouts because successes or failures of early waves do not provide sufficient customer feedback to improve rollout successes for the later waves. Lack of knowledge in how customers use products and whether they urgently need these modernized feature updates will result in high rollback rates and multiple repetitive rounds within the same customer segments for product or feature promotion.

In yet another example, new or existing customers can respond through a message center showing interest of early rollouts as pilot audience to try new features and/or sale promotions. However, it always takes time (e.g., at least a month) to collect customer feedback and decide pilot candidates for free trials, and not applicable to monthly feature updates. Further, customer feedback can be biased due to curiosity of new changes on the product and very likely to roll back to original settings after trials.

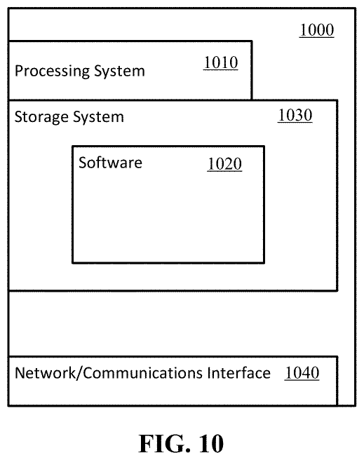

Instead of using these rollout approaches, a SaaS provider, such as SaaS provider 110, can use a smart rollout recommendation system 140 and the processes described herein. The smart rollout recommendation system (“rollout system”) 140 can include a machine learning (ML) processor 150 (noting that more than one hardware processor may be part of the ML processor 150) and a storage resource 160, which can store models and other information for performing the processes described herein. The rollout system 140 can be implemented by one or more servers embodied as described with respect to computing system 1000 as shown in FIG. 10.

SaaS provider 110 may include or communicate with services that are used to direct updates and content to tenants. Through use of the smart rollout recommendation system 140, SaaS provider 110 can deliver modernized product features and/or targeted content to the right customers with fast and safe rollout schedules, reducing the time required for 100% release to the public, increasing the rollout campaign success rates, and identifying problems quicker. In some cases, rollout system 140 provides the services for SaaS provider 110 to execute a rollout of a feature to identified targets. In some cases, rollout system 140 provides the target information to separate rollout services that communicate with the rollout system 140 to obtain the targets.

One or more tenant information providers (not shown) can be part of or communicate with the SaaS provider 110 (and rollout system 140) to assist with rollout of a new feature. A tenant information provider is a component that manages and/or collects information about a tenant such as application topologies for an enterprise (e.g., the infrastructure, computing devices, and applications installed thereon), telemetry, and account information. In all cases, any customer data that flows between components are subject to privacy and security measures. Indeed, it is expected that appropriate privacy and security policies and regulations are followed. For example, information provided to rollout system 140 should be cleansed of personally identifiable information (PII data) of users.

In some cases, a plurality of tenant information providers is used, where each tenant information provider captures a particular attribute of interest for the rollout system 140. For example, one provider can store information on inventory for a tenant, including devices and frequency of updates to applications, another provider can maintain information on each device's management type (e.g., IT-admin control or not), another provider can maintain information on deployment of updates and new features (and may involve telemetry to identify issues with the product or the install), and another provider can maintain (and even generate) tenant profiles (e.g., number of seats, industry type, customer segment group). Of course, more or fewer providers may be used.

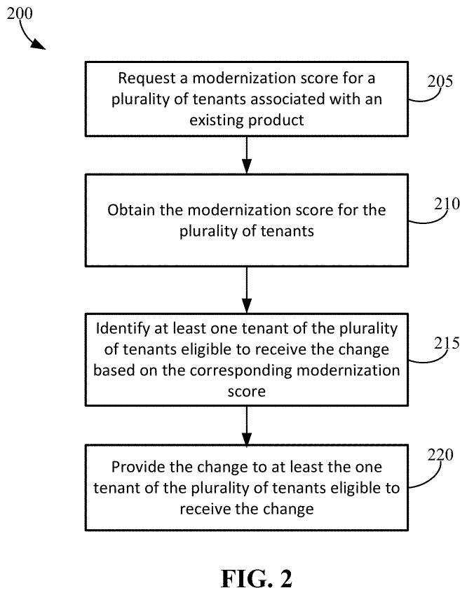

The rollout system 140 utilizes information collected and/or managed by the various tenant information providers in performing processes such as described with respect to FIGS. 2-4. Rollout system 140 is thus used to identify targeted tenants (and even a particular subset within a tenant) for rollout of a new or updated feature for SaaS provider 110.

Components (computing systems, storage resources, and the like) in the operating environment may operate on or in communication with each other over a network 170. The network 170 can be, but is not limited to, a cellular network (e.g., wireless phone), a point-to-point dial up connection, a satellite network, the Internet, a local area network (LAN), a wide area network (WAN), a Wi-Fi network, an ad hoc network, or a combination thereof. Such networks are widely used to connect various types of network elements, such as hubs, bridges, routers, switches, servers, and gateways. The network 170 may include one or more connected networks (e.g., a multi-network environment) including public networks, such as the Internet, and/or private networks such as a secure enterprise private network.

As will also be appreciated by those skilled in the art, communication networks can take several different forms and can use several different communication protocols.

Communication to and from the applications at the various devices and systems may be carried out, in some cases, via application programming interfaces (APIs). An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

The described smart rollout recommendation system 140 can incorporate machine learning algorithms (e.g., via ML processor 150) to study customer similarities as well as their user behaviors and to quantify the likelihood of each customer to accept new changes of product, and thus achieving high rollout speed and acceptance rates.

The described smart rollout recommendation system 140 can include a calibration model (e.g., stored at resource 160 and used by ML processor 150) to modify the capacity estimate of a customer to absorb change, if necessary, according to customer feedback from existing waves, and can optimize future rollout waves to increase rollout success rates.

For example, Equation Error! Reference source not found. shows the definition of modernization score, the measurement of all-up capacities of a customer (e.g., tenant 120 or tenant 130) to absorb modernized app changes (or in other words, the probabilities of a customer accepting the changes campaigns are initiating). Equation (1) is:

$$Modernization Score = {\sum }_{i} ( Feature {Weight}_{i} \times Feature {Strength}_{i} \times Feature {Score}_{i} ) \qquad ( 1 )$$

where the subscript i refers to the index of features used to compute the modernization score.

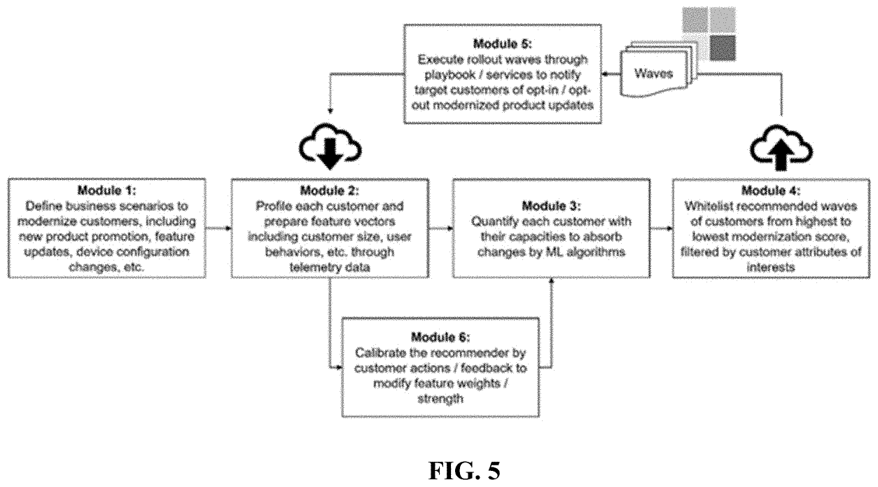

Here, the features can be based on certain attributes for the tenants, including, but not limited to, application software usage, security, and user device management. For example, feature sets can be selected from tenant/customer profiles having monetary/monetization attributes and modernization attributes as described with respect to Module 2 of FIG. 5.

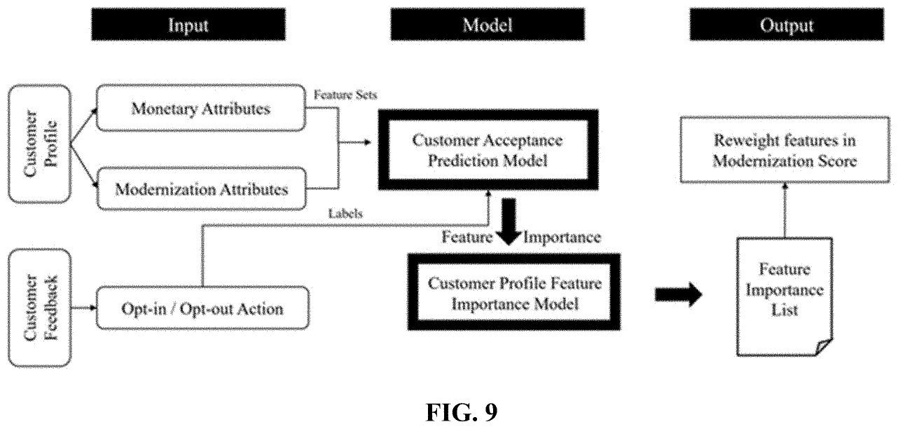

Feature weights are set as equal for initial waves and can be automatically updated with subsequent waves when customer feedback strongly support model calibration (see e.g., Module 6 of FIG. 5 and FIG. 9). Feature score, ranged from 0 to 100, measures the modernization status of the customer represented by the feature. The higher the score, the higher probability of campaign success learnt from the feature. Scoring functions can be continuous (e.g., normal, exponential) or discrete (e.g., stepwise constant) dependent on business problems to solve. Feature strength, ranged from 0 to 1, measures the confidence level of the feature score and is given by a customized function, e.g., a step function to represent tier-based health status, a sigmoid function to represent continuously increasing confidence with higher collaboration usage density, etc. Depending on the business needs and the specific business questions to answer, weights are assigned accordingly and amplified by multiplication.

Advantageously, the described smart rollout recommendation system 140 can provide interpretable, quantifiable, and flexible catering for different business needs and can be applicable in a variety of scenarios, including new product or feature release and targeted content or promotion.

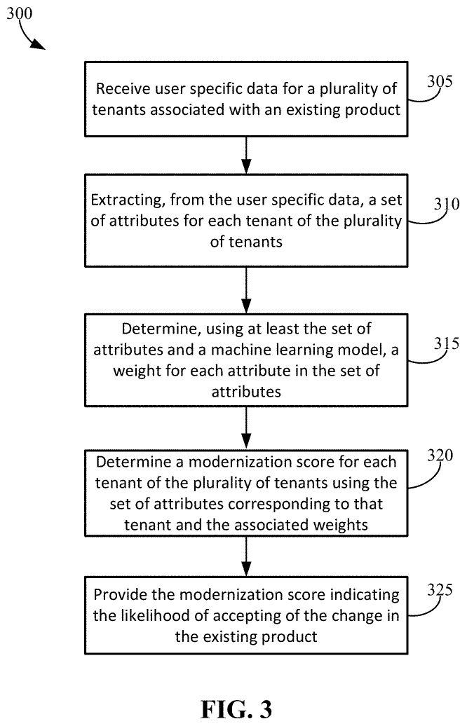

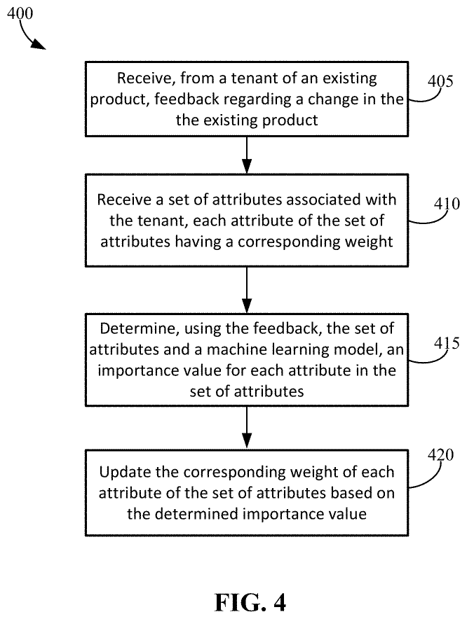

FIG. 2 illustrates an example process flow for providing smart rollout recommendations according to certain embodiments of the invention; FIG. 3 illustrates an example process flow for determining a modernization score indicating a likelihood of accepting a change in an existing product according to certain embodiments of the invention; and FIG. 4 illustrates an example process flow for providing model calibration in a system for providing smart rollout recommendations according to certain embodiments of the invention.

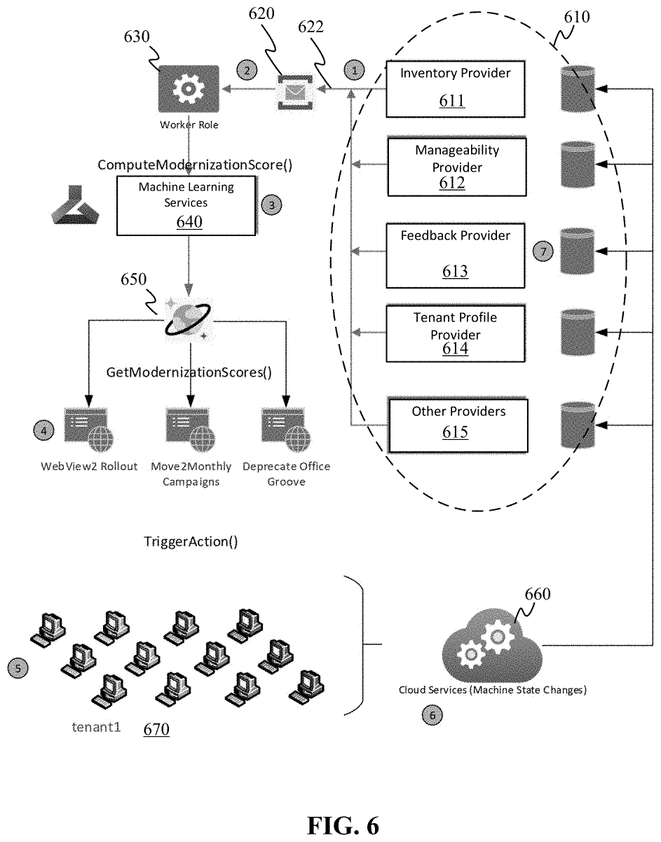

A rollout system (e.g., rollout system 140 described with respect to FIG. 1) performing process 200 described with respect to FIG. 2, process 300 described with respect to FIG. 3, and process 400 described with respect to FIG. 4, can be embodied with respect to system 1000 as described with respect to FIG. 10. In some cases, aspects of processes 200, 300, and 400 can be performed as services such as outlined in the implementation of FIG. 6.

Referring to FIG. 2, when performing a rollout of a new or updated feature, a rollout system can perform process 200. For example, the rollout services of rollout system can request (205) a modernization score for a plurality of tenants associated with an existing product. As mentioned above, a modernization score indicates a likelihood of accepting a change in the existing product. As described with respect to process 300 of FIG. 3, the modernization score can be computed for each tenant using at least a weighted set of attributes associated with that tenant (e.g., following Equation 1). The weighted set of attributes corresponding to at least application software usage, security, and user device management.

In response to the request, the rollout services can obtain (210) the modernization scores for the plurality of tenants indicating the likelihood of accepting the change. The rollout services can identify (215) at least one tenant of the plurality of tenants eligible to receive the change based on that tenant's corresponding modernization score. It is also possible to identify subsets of devices for a particular tenant suitable for rollout, depending on granularity provided by scores. The rollout services can provide (220) the change to the at least one tenant of the plurality of tenants eligible to receive the change. The execution of the rollout in step 220 can be performed in waves (see e.g., Module 4 and 5 described with respect to FIG. 5).

Referring to process 300 of FIG. 3, machine learning services of the rollout system can receive (305) user specific data for a plurality of users associated with an existing product. The plurality of users is associated with particular tenants of a SaaS provider (of the existing product) utilizing the rollout system. The machine learning services can receive the user specific data from tenant information providers.

The machine learning services of the rollout system can extract (310), from the user specific data, a set of attributes for each user of the plurality of users. The user specific data can be in the form of tenant profiles. The set of attributes correspond to at least application software usage, security, and user device management. The machine learning services of the rollout system can determine (315), using at least the set of attributes and a machine learning model, a weight for each attribute in the set of attributes. The rollout system can determine (320) a modernization score indicating a likelihood of accepting a change in an existing product for each tenant of the plurality of tenants using the set of attributes corresponding to that tenant and the associated weights. Then, the machine learning services of the rollout system can provide (325) the modernization score indicating the likelihood of accepting of the change in the existing product determined for each user of the plurality of users. The modernization score can be thus obtained by the rollout services such as described in operation 210 of FIG. 2.

Referring to process 400 of FIG. 4, the rollout system can receive (405) feedback regarding a change in an existing product. The feedback can be received from a tenant of the existing product. Collection services may be used to collect the feedback (as described with respect to FIG. 6). The rollout system can receive (410) a set of attributes associated with the tenant, the set of attributes corresponding to at least application software usage, security, and user device management and being used to compute a modernization score indicating a likelihood of tenants to accept changes in the existing product, wherein each attribute of the set of attributes has a corresponding weight. The rollout system can determine (415), using the feedback, the set of attributes, and a machine learning model, an importance value for each attribute in the set of attributes; and the rollout system can update (420) the corresponding weight of each attribute of the set of attributes based on the determined importance value, wherein the updated corresponding weight is used to compute the modernization score. An implementation of process 400 for calibrating the machine learning model is shown in FIG. 9.

FIG. 5 illustrates an example smart rollout recommendation system workflow according to an embodiment of the invention. Referring to FIG. 5, a rollout system can be customized for an operational environment through six modules.

Module 1: Define business scenarios to modernize customers, including new product promotion, feature updates, device configuration changes, etc. For example, the platform can receive the parameters for the desired modernization schedules. One modernization schedule could be changing from semi-annual feature and security updates to a monthly update cadence. It is desirable to identify the customers (and the information channels) to obtain opt-in/opt-out for a modernization schedule.

Module 2: Profile each customer and prepare feature vectors including customer size, user behaviors, etc., through telemetry data. As mentioned above, tenant information providers can provide tenant information to the rollout system. It should be understood that this tenant information would be collected in accordance with appropriate privacy and security policies and regulations.

Through the profiles, it is possible to customize a business scenario as identified in Module 1 for a specific business domain and targeted business customers. In Module 2, the profiles are used to find common attributes so that customers are segmented with the maximum divisor of those attributes, e.g., customer segment group, industry, country, number of monthly active users, current subscription channel, feature update cadence, percentage of devices under IT-admin control, etc. The use of common attributes generalizes this approach for diversified applications of rollout recommendations, which makes different campaign drivers easily adapt/customize the rollout system for application in specific business scenarios.

The common attributes for the customer profiles can include two categories of attributes:

Monetization attributes: these attributes describe the customer size and revenue contributions to a particular SaaS application, including number of purchased seats, number of monthly active users, business SKU category, customer segment group (enterprise, SMC—small, medium, and corporate, SMB—small and medium business, EDU—education, government), is strategic/government customer, geographic location, etc.

Modernization attributes: these attributes measure the modernization status of customers on latest features/security updates, including subscribed channel, device update cadence (whether the update behavior is ad-hoc or consistently sustainable), device management type (e.g., whether most of their devices are under IT-admin control or using certain backend policies), collaboration intensity, browser usage, usage of a particular product feature, etc.

Module 3: Quantify each customer with their capacities to absorb changes by ML algorithms.

Machine Learning (ML) algorithms can be used to classify the customers with respect to the likelihood that they would accept a change in an existing product. For example, a modernization score can be generated for a customer using a classification algorithm. Examples of classification algorithms that may be used as part of generating a modernization score include, but are not limited to, logistic regression, Naive Bayes classifier, K-Nearest Neighbors, Decision Trees (including Random Forest), and Support Vector Machines. In a specific implementation described herein, a decision tree-based ML algorithm is used, the Light Gradient Boosting Machine (LightGBM), which is described in detail with respect to Module 6.

An example of the modernization score used to move customers to monthly update cadence is presented in Equation (2):

$$Modernization Score = 0.5 \times Currency Health Strength \times Currency Health Score + 0.5 \times Device Manageable Strength \times Device Manageable Score \qquad ( 2 )$$

Here, currency health and device manageability are used to measure modernization status of a customer.

Currency health describes whether customers are keeping devices updated on a sustainable monthly cadence, and therefore reflects whether customers show interests and have capacities to subscribe on latest feature/security updates released every month. If customers are consistently updating their devices to the latest release of the SaaS application, then it is assumed that there is enough evidence to believe that the customers are willing to absorb new changes and take any suggestions to modernize their application use. Table 1 shows how each customer is classified into different levels of currency health.

TABLE 1
Currency health score definition.

| Currency | | Currency |
|---|---|---|
| Health | | Health |
| Status | Currency Health Definition | Score |
| Healthy | ≥80% devices are on recent versions | 100 |
| | for ≥5 months of the past 6 months | |
| Trending | ≥80% devices are on recent versions | 80 |
| Healthy | for the most recent 2 months | |
| Warning | Having enough diagnostic data but not | 50 |
| | in any of the four currency health | |
| | statuses | |
| Unhealthy | ≥80% devices are NOT on recent | 25 |
| | versions for 3 months of the past | |
| | 6 months | |
| Critically | ≥50% devices are NOT on recent | 0 |
| Unhealthy | versions for >3 months of the past | |
| | 6 months | |
| Unknown | Not showing enough diagnostic data | 50 |

Note: Recent version is an app version which was released in the reporting month or is the latest two builds from the previous month.

Currency health strength is tabulated by predominant cadence of customer devices, shown in Table 2. If a customer has most of the devices subscribed on monthly channels, there is a high confidence of their reported currency health representing their capacities to absorb new changes.

TABLE 2
Currency health strength definition.

| | | Currency |
|---|---|---|
| Predominant | | Health |
| Cadence | Predominant Cadence Definition | Strength |
| Monthly | ≥70% devices subscribed on monthly | 1.0 |
| | channels (current channel or monthly | |
| | enterprise channel) | |
| Mixed | ≥70% devices subscribed on monthly | 0.9 |
| | channels and <70% devices subscribed | |
| | on semi-annual channels | |
| Semi-Annual | ≥70% devices subscribed on semi-annual | 0.8 |
| | channels (semi-annual channel or semi-annual | |
| | channel preview) | |

Device manageability describes the management status of business customers' devices, whether under IT-admin's control (customer consent required before making changes) or connected to a backend service (directly exposed to changes from server). Strong evidence of active IT-admin presence (either app policies are set, or devices are managed by one of the management tools) in the business customer can require careful evaluations of the scenarios before pushing changes onto their devices, which results in field engagement to ask for customer consent. And therefore, customers with devices under IT-admin control are usually not prioritized to deliver modernized changes through massive campaigns. Table 3 and Table 4 show how a device manageability score and the corresponding feature strength, respectively, are computed. Note that the device manageability strength is defined as the product of strength values from the two features.

TABLE 3
Device manageability score definition.

| Device | | Device |
|---|---|---|
| Management | | Manageability |
| Type | Device Management Type Definition | Score |
| Unmanaged | ≥70% devices not managed by IT-admins | 100 |
| Mixed | Having enough diagnostic data but | 60 |
| | neither unmanaged nor managed | |
| Managed | ≥50% devices managed by IT-admins | 25 |
| Unknown | Not showing enough diagnostic data | 50 |

TABLE 4
Device manageability strength definition.

| | | | Device |
|---|---|---|---|
| | Feature | | Manageability |
| Feature Name | Value | | Strength |
| Has the customer logged onto Apps | <1 | month | 0.50 |
| Admin Center in the past few months? | 1-3 | months | 0.80 |
| When is the latest sign-in? | 3-6 | months | 0.90 |
| | 6-12 | months | 0.95 |
| | >12 | months | 0.99 |

| | | |
|---|---|---|
| | Never | 1.00 |
| | signed-up | |
| Are there any devices manually | Yes | 0.50 |
| enrolled on monthly enterprise channel? | No | 1.00 |

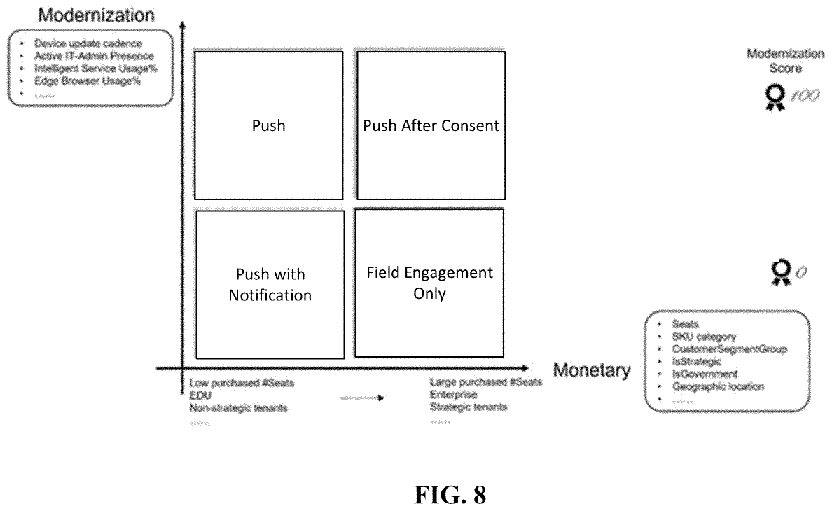

Module 4: Whitelist recommended waves of customers from highest to lowest modernization score, filtered by customer attributes of interests. Here, the attributes identified in Module 2 along with the quantification of each customer using a modernization score as described in Module 3 can be used to identify the order for deploying an update or change. For example, the customers can be ranked according to modernization score and rollout of an update or new feature can follow the order of the ranked customers. In some cases, a subset of the customers having certain attributes of interest can be ordered according to their score and the rollout be to that subset of customers in the suggested waves. FIG. 8 illustrates an example mapping of modernization score to wave rollout recommendation.

Module 5: Execute rollout waves through playbook/services to notify target customers of modernized product updates. Based on the whitelist recommended waves from Module 4, the actual roll out can be executed to deploy the updates or new features.

Once the rollout waves are finally signed off, notifications can be sent to customers to remind them of any required actions to accept/decline modernized changes. The process can be initially driven by manual playbooks and gradually onboarded to automatic services. At the same time, backend services can measure and track customer health after modernized changes and collect customer feedback as well as their acceptance rates via any suitable telemetry methods.

Module 6: Calibrate the recommender by customer actions/feedback to modify feature weights/strength. As part of the continual improvement of the rollout system, feedback from the rollout waves can be used to calibrate the machine learning algorithms described in Module 3. FIG. 9 illustrates an example calibration model that can be used to calibrate the algorithms used to generate the modernization scores.

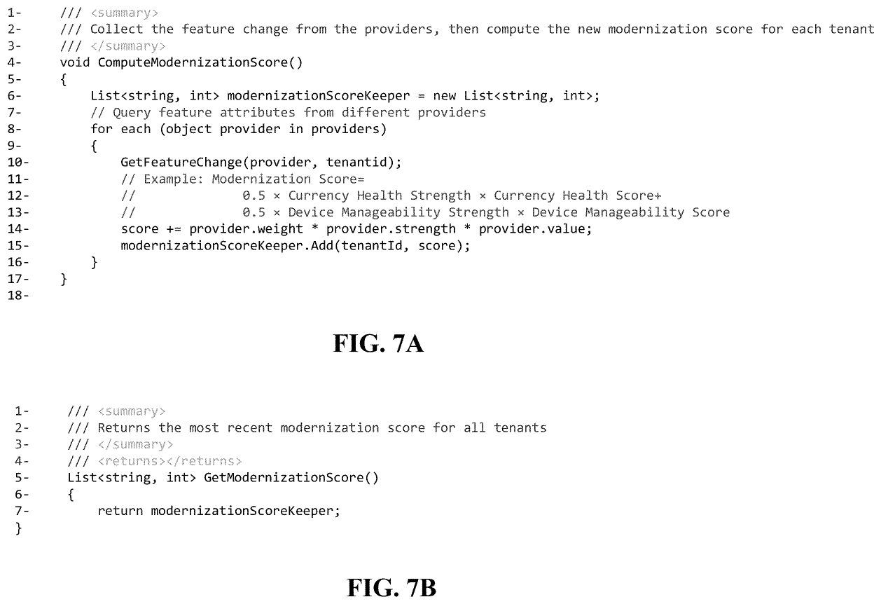

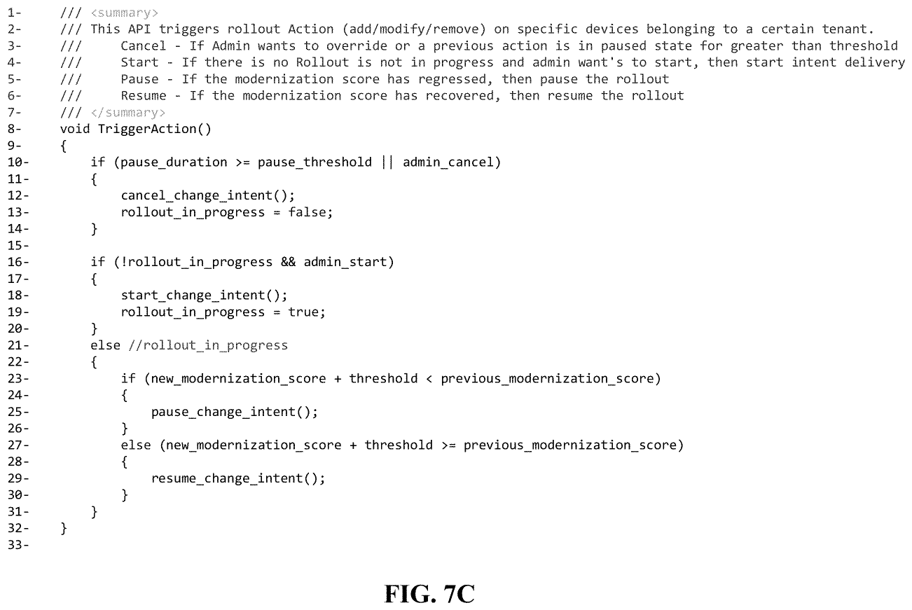

FIG. 6 illustrates an example smart rollout recommendation system cloud services workflow according to an embodiment of the invention. FIGS. 7A-7C show pseudocode for operations shown in FIG. 6.

Referring to FIG. 6, an implementation of services associated with the rollout system 140 in operating environment 100 of FIG. 1 can include tenant information providers 610 including inventory provider 611, manageability provider 612, feedback provider 613, tenant profile provider 614, and optionally other providers 615, that provide messages 620 over Service Bus 622 to Worker Role 630; Machine Learning service provider 640, rollout services 650, and collection services 660.

The monetary attributes and modernization attributes for each customer (e.g., tenant 670) are provided by individual providers. Each provider cleanses the data and transforms the data into a format that is consumable for optimization (e.g., pivoted by tenantId, which identifies a tenant/customer of the plurality of tenants/customers that may be serviced by the rollout system).

Here, the Inventory Provider 611 stores source of truth about the count of devices, their add-in information, the installed applications, the versions, how current are these versions and how frequently are they receiving updates from a SaaS provider. The Inventory Provider helps with providing Currency Health related information for each tenant (such as described above with respect to Module 3).

The Manageability Provider 612 stores source of truth about each device's management type and aggregates the predominant manageability type for each tenant.

The Feedback Provider 613 tracks feedback across several products including the features the Rollout service (e.g., of rollout services 650) is responsible to make changes on.

The Tenant Profile Provider 614 stores source of truth about tenant monetary information such as total paid seats, industry type, customer segment group etc., for each tenant.

The Other Providers 615 represents other providers that may be plugged in to enhance the feature set.

The data from the providers 610 are provided as messages 620 to Worker Role 630.

The Service Bus 622 can be a web endpoint on which the Worker Role 630 performs a service that A) listens for events (e.g., messages 620) posted on the service bus 622 so that B) the appropriate computations can be performed and then C) pushes messages back on the bus for other services to consume.

The ML service provider 640 invokes the machine learning algorithms used to generate the modernization scores, for example via ML processor 150 as described with respect to FIG. 1.

For the workflow, in step 1, every change detected by any provider 610 publishes a change message/event 620 in Service Bus 622. In step 2, Worker Role 630, picks up the messages 620 from the providers and queues the task. In step 3, ML service provider 640 invokes ComputeModernizationScore( ) API (see FIG. 7A), which causes the generation of the modernization scores. In step 4, Rollout Services 650 (example: WebView2 Rollout) queries the GetModernizationScore( ) (see FIG. 7B) and calls TriggerAction( ) (see FIG. 7C) on eligible tenant devices at tenant 670 (e.g., according to the whitelist recommended waves as described with respect to Module 4). In step 5, the change (add/modify/delete) happens on the target devices at tenant 670; and in step 6, the machine state changes get collected by services 660 and recorded in storage for each provider 610 for potential calibration feedback as described with respect to Module 6. Example: Customer feedback triggers a change event to recycle the flow from steps 1-6.

FIG. 8 illustrates an example mapping of modernization score to wave rollout recommendation according to certain embodiments of the invention.

FIG. 8 describes how the modernization score and monetization attributes are combined to take actions and define executive waves for smart rollouts. As previously described, modernization scores relate to device update cadence, active IT-Admin presence, intelligent service usage, browser usage, etc. In the illustrated example, monetary scores relate to seats, SKU category, customer segment group, strategic group, government group, geographic location, etc. The four categories for rollout actions shown in the figure are Push, Push with notifications, Push after consent, and Field engagement only.

Push: customers with low monetary values but showing high modernization score. Good starting point to launch campaigns as they have already onboarded with modernized changes and not have big market value impacts even if they push back.

Push with notifications: customers with low monetary values and large modernization improvement potentials. Significant changes can be evident for the customers, so notifications are sent for awareness. Not much to lose even if they push back changes.

Push after consent: customers with high monetary values and high modernization score. Large enterprise customers we value, and we want to make sure they agree with the modernized changes before direct exposure.

Field engagement only: customers with high monetary values but low modernization score. Less likely to accept modernized changes and assigned dedicated representatives to walk them through, advertise for potential benefits after changes.

Waves are then executed sequentially based on the priorities of the push actions (highest to lowest: push>push with notification>push after consent>field engagement only) and additional field filters campaign drivers are concerned about (e.g., total addressable market to achieve milestone business goals). The size of the wave cohorts is dependent on business needs, including the complexity of rollouts and granularity of management desired, and determines how the modernization score is grouped into sizeable buckets to help select eligible customers.

FIG. 9 illustrates an example flowchart diagram to describe an ML-driven calibration model according to an embodiment of the invention.

The calibration model can a combined supervised and unsupervised learning model, where the supervised part learns from customer opt-in/opt-out choices the leading indicators of campaign successes/failures, while the unsupervised part consumes the feature importance values and adjust on the feature weight in Equation Error! Reference source not found. (the modernization score).

Here, input to the ML-driven calibration model includes feature sets from the monetary/monetization attributes and the modernization attributes (which can be obtained from the customer profile). Labels can be applied from customer feedback (e.g., opt-in/opt-out action). Two models are shown in this implementation: a customer acceptance prediction model, which takes in the features sets and labels, and customer profile feature importance model, which uses the feature importance information from the customer acceptance prediction model. The output of the second model (the customer profile feature importance model) can be a feature importance list, which is then used to reweight features in the modernization score.

Model calibration is dependent on the tolerance of model performance. If the model precision and/or recall is smaller than X % (X determined by the specific business scenario), then the calibration model will be triggered. Customer acceptance/refusal action will be marked as positive/negative labels, and classification models are trained with customer attributes (both included in smart rollout recommender and ones that stakeholders believe are good candidates to add). Feature importance tests can be conducted by the best performers in candidate models and feature weights will be adjusted accordingly.

For the example implementation, LightGBM was used for training and validating the supervised model due to its high precision/recall/area under the curve (AUC) (AUC is a measure of classification accuracy based on an estimate of the probability that a classifier will rank a randomly chosen positive instance higher than a randomly chosen negative instance).

After rolling out initial pilot waves for the “move-to-monthly” campaigns, customer feedback was collected and a controlled experiment to evaluate the model performance was conducted. For the four pilot waves, the precision/recall of the small rollout recommendation system is compared against the traditional approach of selecting rollout customers simply by monetization attributes (customer size, total addressable market, customer segment group, location, etc.).

Results from the experimental pilots indicated that small rollout recommender outperforms the traditional approach across all waves with consistently higher precision. Further splits of different cutoff scenarios to determine high versus low modernization score revealed tradeoffs of precisions and recalls when the recommendation system was applied. Model precisions positively correlate with modernization score cohorts. The higher the score in the cohorts, the higher the precision model performed. However, conservative rollouts with higher modernization score will sacrifice recalls as it is possible to miss a good number of candidates who have potentials to absorb new changes. Based on the pilot data, suggestions of model use include: push customers with modernization score higher than 90 to prioritize precision and reduce false positives; push customers with modernization score higher than 50 to prioritize rollout speed and increase customer exposure.

FIG. 10 illustrates components of a computing system that may be used in certain embodiments described herein. Referring to FIG. 10, system 1000 may be implemented within a single computing device or distributed across multiple computing devices or sub-systems that cooperate in executing program instructions. The system 1000 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 1000 can include a processing system 1010, which may include one or more processors and/or other circuitry that retrieves and executes software 1020 from storage system 1030. Processing system 1010 may be implemented within a single processing device but may also be distributed across multiple processing devices or sub-systems that cooperate in executing program instructions.

Storage system(s) 1030 can include any computer readable storage media readable by processing system 1010 and capable of storing software 1020. Storage system 1030 may be implemented as a single storage device but may also be implemented across multiple storage devices or sub-systems co-located or distributed relative to each other. Storage system 1030 may include additional elements, such as a controller, capable of communicating with processing system 1010. Storage system 1030 may also include storage devices and/or sub-systems on which data is stored. System 1000 may access one or more storage resources in order to access information to carry out any of the processes indicated by software 1020.

Software 1020, including routines for performing processes, such as process 200 described with respect to FIG. 2, process 300 described with respect to FIG. 3, and process 400 described with respect to FIG. 4, may be implemented in program instructions and among other functions may, when executed by system 1000 in general or processing system 1010 in particular, direct the system 1000 or processing system 1010 to operate as described herein.

In embodiments where the system 1000 includes multiple computing devices, in some cases, the computing devices can be installed at geographically distributed locations. In other cases, the multiple computing devices can be installed at a single geographic location, such as a server farm or an office.

A communication interface 1040 may be included, providing communication connections and devices that allow for communication between system 1000 and other computing systems (not shown) over a communication network or collection of networks (not shown) or the air.

In some embodiments, system 1000 may host one or more virtual machines.

Alternatively, or in addition, the functionality, methods, and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

1. A method comprising:
requesting a modernization score for each of a plurality of tenants associated with an existing product, the modernization score indicating a likelihood of accepting a change in the existing product and being computed for each tenant using at least a weighted set of attributes associated with that tenant, the weighted set of attributes corresponding to at least application software usage, security, and user device management, each tenant comprising a plurality of computing devices;
obtaining the modernization score for each of the plurality of tenants indicating the likelihood of accepting the change;
identifying at least one tenant of the plurality of tenants eligible to receive the change based on the corresponding modernization score; and
providing the change to the at least one tenant of the plurality of tenants eligible to receive the change.

2. The method of claim 1, further comprising:
generating the modernization scores.

3. The method of claim 2, wherein generating the modernization scores comprises determining
$$Modernization Score = {\sum }_{i} ( Feature {Weight}_{i} \times Feature {Strength}_{i} \times Feature {Score}_{i} )$$
where i is from an index of a set of attributes for the weighted set of attributes.

4. The method of claim 2, wherein generating the modernization scores comprises:
receiving user specific data for the plurality of tenants associated with the existing product;
extracting, from the user specific data, a set of attributes for each tenant, the set of attributes corresponding to at least application software usage, security, and user device management;
determining, using at least the set of attributes and a machine learning model, a weight for each attribute in the set of attributes; and
calculating the modernization score for each tenant from the weighted set of attributes using the weight for each of the attributes.

5. The method of claim 4, wherein the set of attributes comprises monetization attributes and modernization attributes.

6. The method of claim 2, further comprising:
receiving, from a particular tenant of the existing product, feedback regarding a change in the existing product;
receiving a set of attributes associated with the particular tenant, the set of attributes corresponding to at least application software usage, security, and user device management and being used to compute the modernization score, wherein each attribute of the set of attributes has a corresponding weight;
determining an importance value for each attribute in the set of attributes using the feedback, the set of attributes, and a machine learning model; and
updating the corresponding weight of each attribute of the set of attributes based on the determined importance value to calibrate the machine learning model, wherein the updated corresponding weight is used to compute an updated modernization score.

7. The method of claim 6, wherein the machine learning model comprises a customer acceptance prediction model and a customer profile feature importance model.

8. The method of claim 6, wherein the set of attributes comprises monetization attributes and modernization attributes.

9. The method of claim 6, wherein the feedback comprises information on opt-in of the change in the existing product and opt-out of the change in the existing product.

10. The method of claim 1, wherein the providing of the change to the at least one tenant comprises directing waves of users from highest to lowest modernization score.

11. The method of claim 10, further comprising filtering the waves of users by attributes.

12. A rollout recommender system comprising:
a processing system;
a storage system; and
instructions stored on the storage system that when executed by the processing system direct the rollout recommender system to at least:
receive user specific data for a plurality of tenants associated with an existing product, each tenant comprising a plurality of computing devices;
extract, from the user specific data, a set of attributes for each user of the plurality of users, the set of attributes corresponding to at least application software usage, security, and user device management;
determine, using at least the set of attributes and a machine learning model, a weight for each attribute in the set of attributes;
determine a modernization score indicating a likelihood of accepting a change in an existing product for each tenant of the plurality of tenants using the set of attributes corresponding to that tenant and the associated weights; and
provide the modernization score indicating the likelihood of accepting of the change in the existing product determined for each user of the plurality of users.

13. The system of claim 12, wherein the instructions to determine, using at least the set of attributes and the machine learning model, the weight for each attribute in the set of attributes directs the rollout recommender system to:
receive, from a particular tenant of the existing product, feedback regarding the change in the existing product;
receive the set of attributes associated with the particular tenant;
determine an importance value for each attribute in the set of attributes using the feedback, the set of attributes, and the machine learning model; and
update the corresponding weight of each attribute of the set of attributes based on the determined importance value to calibrate the machine learning model, wherein the updated corresponding weight is used to compute an updated modernization score.

14. The system of claim 13, wherein the machine learning model comprises a customer acceptance prediction model and a customer profile feature importance model.

15. The system of claim 13, wherein the set of attributes comprises monetization attributes and modernization attributes.

16. The system of claim 13, wherein the feedback comprises information on opt-in of the change in the existing product and opt-out of the change in the existing product.

17. A computer-readable storage medium having instructions stored thereon that, when executed by a processing system, perform a method comprising:
receiving, from a tenant of an existing product, feedback regarding a change in the existing product, the tenant comprising a plurality of computing devices;
receiving a set of attributes associated with the tenant, the set of attributes corresponding to at least application software usage, security, and user device management and being used to compute a modernization score indicating a likelihood of tenants to accept changes in the existing product, wherein each attribute of the set of attributes has a corresponding weight;
determining, using the feedback, the set of attributes, and a machine learning model, an importance value for each attribute in the set of attributes; and
updating the corresponding weight of each attribute of the set of attributes based on the determined importance value to calibrate the machine learning model, wherein the updated corresponding weight is used to compute the modernization score.

18. The medium of claim 17, wherein the machine learning model comprises a customer acceptance prediction model and a customer profile feature importance model.

19. The medium of claim 17, wherein the set of attributes comprises monetization attributes and modernization attributes.

20. The medium of claim 17, wherein the feedback comprises information on opt-in of the change in the existing product and opt-out of the change in the existing product.
